(19) United States
(12) Patent Application Publication
(10) Pub. No.: US 2014/0032700 A1
(43) Pub. Date: Jan. 30, 2014

(54) DATA PROCESSING METHOD AND MOBILE TERMINAL

(71) Applicant: FUJITSU LIMITED, Kawasaki-shi (JP)

(72) Inventors: Koji Kurihara, Kawasaki (JP); Koichiro Yamashita, Hachioji (JP); Takahisa Suzuki, Kawasaki (JP); Hiromasa Yamauchi, Kawasaki (JP); Toshiya Otomo, Kawasaki (JP); Naoki Odate, Akirumo (JP)

(73) Assignee: FUJITSU LIMITED, Kawasaki-shi (JP)

(21) Appl. No.: 14/041,566

(22) Filed: Sep. 30, 2013

Related U.S. Application Data
(63) Continuation of application No. PCT/JP2011/058143, filed on Mar. 30, 2011.

(51) Int. Cl. H04L 29/08

(52) U.S. Cl. CPC H04L 67/06
USPC 709/213

(57) ABSTRACT

A data processing method is executed by a first device, and includes suspending execution of a first process by the first device that belongs to a first device group that includes plural devices; saving based on a request for execution of a second process from a second device that belongs to a second device group that includes plural devices, process information of the first process to shared memory that is set in each of the devices of the first device group and shared by the devices of the first device group; and releasing the saving of the process information of the first process consequent to completion of the execution of the second process.

### CROSS REFERENCE TO RELATED APPLICATIONS

This application is a continuation application of International Application PCT/JP2011/058143, filed on Mar. 30, 2011 and designating the U.S., the entire contents of which are incorporated herein by reference.

### FIELD

The embodiment discussed herein is related to a mobile terminal and a data processing method of performing distributed processing.

### BACKGROUND

Conventionally, when a master terminal controls multiple mobile terminals and performs distributed processing, mobile terminals connected to a base station to which the master terminal is connected are set as a group that executes the distributed processing. Under the control of the master terminal, the mobile terminals making up the group execute the distributed processing thereamong. The distributed processing executed among the mobile terminals includes a process requiring exclusive control.

When exclusive control is performed among the mobile terminals, one process subject to the distributed processing is kept suspended until a different process has ended. As a result, a central processing unit (CPU) of a terminal having a suspended process becomes idle.

According to a related conventional technique, data of multiple point-of-sale (POS) devices interconnected via a network is compressed and the compressed data is saved in each POS device as backup data (see, e.g., Japanese Laid-Open Patent Publication No. 2003-67232). According to another known technique, a CPU is lent out for the execution of a process initiated by a different CPU, based on load information of CPUs in a group (see, e.g., Japanese Laid-Open Patent Publication No. H8-77026). According to yet another technique, a memory area for saving process information of a suspended process is prepared in a device (see, e.g., Japanese Laid-Open Patent Publication No. S64-076228).

A mobile terminal whose CPU is in an idle state may be a mobile terminal that is connected to multiple base stations and belongs to multiple groups. In such a case, because the CPU is in the idle state, the mobile terminal can undertake the distributed processing of another group while the distributed processing of a given group is suspended.

However, the intermediate process result of the distributed processing of the given group that is suspended by exclusive control is present in the memory of the mobile terminal whose CPU in the idle state. If the size of the memory of the mobile terminal is small and the mobile terminal undertakes distributed processing of another group, the intermediate process result of the suspended processing is overwritten with the process result of the distributed processing of the other group, arising in a problem.

In other words, the process result of the distributed processing of the given group disappears, making it impossible for the mobile terminal to resume the distributed processing of the given group.

### SUMMARY

According to an aspect of an embodiment, a data processing method is executed by a first device, and includes suspending execution of a first process by the first device that belongs to a first device group that includes plural devices; saving based on a request for execution of a second process from a second device that belongs to a second device group that includes plural devices, process information of the first process to shared memory that is set in each of the devices of the first device group and shared by the devices of the first device group; and releasing the saving of the process information of the first process consequent to completion of the execution of the second process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of saving a process result to a distributed shared memory area;

FIG. 2 is an explanatory diagram of an example of a network system according to an embodiment;

FIG. 3 is a block diagram of an example of a hardware configuration of a mobile terminal N according to the embodiment;

FIG. 4 is an explanatory diagram of an example of saving of an intermediate process result of distributed processing by the mobile terminal;

FIG. 5 is an explanatory diagram of a specific example of returning an intermediate process result saved in the distributed shared memory area to a work area by the mobile terminal;

FIG. 6 is an explanatory diagram of an example of ending execution of a process of a different group by the mobile terminal;

FIG. 7 is a flowchart of details of a process of creating the distributed shared memory area by a master terminal;

FIG. 8 is a flowchart of details of the process of creating the distributed shared memory area by the mobile terminal; and

FIG. 9 is a flowchart of details of a process of saving a process result to the distributed shared memory area by the mobile terminal.

### DESCRIPTION OF EMBODIMENTS

An embodiment of a data processing method and a mobile terminal will be described in detail with reference to the accompanying drawings.

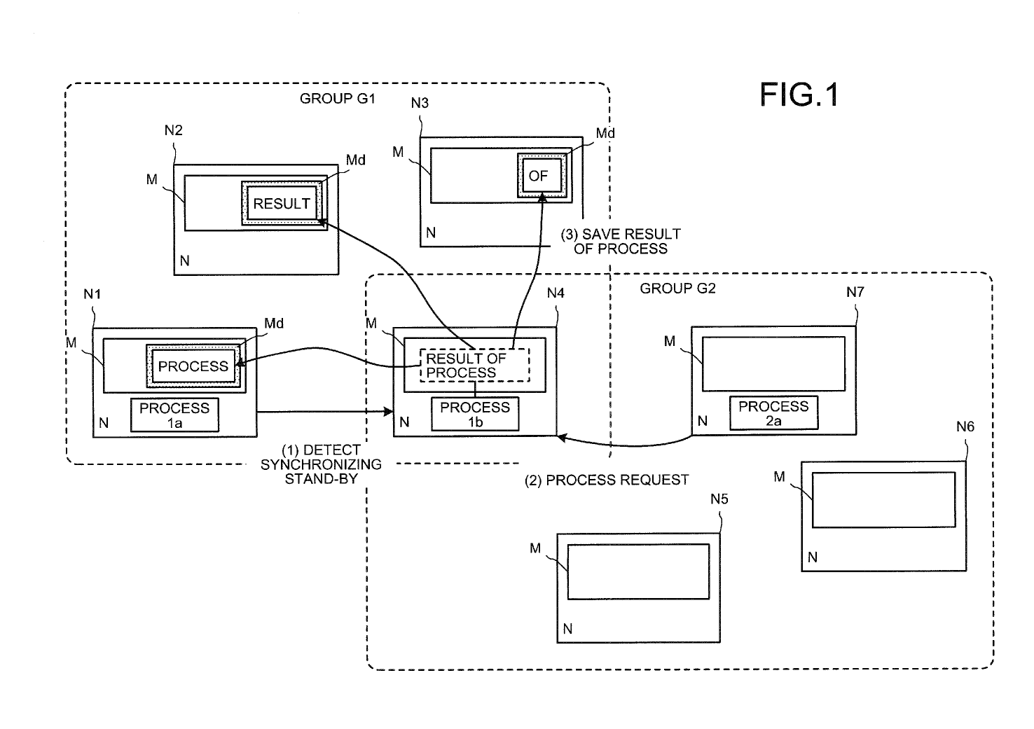

A specific example of saving a process result in a distributed shared memory area Md will be described, referring to FIG. 1.

FIG. 1 is an explanatory diagram of an example of saving a process result to a distributed shared memory area. Mobile terminals N connected to a base station A1 belong to a first device group (hereinafter “group G1”) that executes distributed processing 1. A mobile terminal N1 is a mobile terminal N serving as a master terminal, and mobile terminals N2 to N4 are mobile terminals N serving as slave terminals. The mobile terminal N1 serving as the master terminal distributes and assigns requests for processes 1a and 1b of the distributed processing 1 to the mobile terminals N2 to N4 in the group G1.

In this example, the mobile terminal N1 is executing the process 1a of the distributed processing 1. The mobile terminal N1 assigns the process 1b to the mobile terminal N4, which means the mobile terminal N4 is executing the process 1b. The process result of the process 1b is saved in a memory M of the mobile terminal N4.

Mobile terminals N connected to a base station A2 belong to a second device group (hereinafter “group G2”) that executes distributed processing 2. A mobile terminal N7 is a mobile terminal N serving as a master terminal, and mobile terminals N4 to N6 are mobile terminals N serving as slave terminals. The mobile terminal N7 serving as the master terminal distributes and assigns requests for processes 2a and 2b of the distributed processing 2 to the mobile terminals N4 to N6 in the group G2.

In this example, the mobile terminal N7 is executing the process 2a of the distributed processing 2. The mobile terminal N7 has not assign the process 2b to any mobile terminal yet, which means the process 2b of the distributed processing 2 is not executed by any mobile terminal N.

The mobile terminal N4 belongs to both groups G1 and G2 and can execute the distributed processing 1 or distributed processing 2. However, having a small memory area, the mobile terminal N4 cannot save the process results of multiple processes simultaneously.

The mobile terminals N1 to N3 make distributed shared memory areas Md in the respective memories M. The mobile terminal N4 can save a process result to the distributed shared memory areas Md when necessary.

Saving of the process result of the process 1b by the mobile terminal N4 will be described by taking an example in which the mobile terminal N1 sends to the mobile terminal N4, a request for suspension of the process 1b of the distributed processing 1 for exclusive control.

(1) When the mobile terminal N4 detects synchronizing stand-by in a process of synchronization with the mobile terminal N1, the mobile terminal N4 suspends execution of the process 1b and shifts to an idle state. The mobile terminal N4 then gives notification of the shift to the idle state, to the group G2.

(2) Upon receiving the notification that the mobile terminal N4 has shifted to the idle state, the mobile terminal N7 serving as the master terminal of the group G2 transmits to the mobile terminal N4, a request for the process 2b of the distributed processing 2.

(3) Upon receiving the request for the process 2b, the mobile terminal N4 protects the process result of the process 1b under suspension, and to reserve a work area for the process 2b, saves the process result of the process 1b in the respective distributed shared memory areas Md of the mobile terminals N1 to N3.

The mobile terminal N4 then executes the process 2b, using the memory M thereof. Having finished the process 2b, the mobile terminal N4 transmits the process result of the process 2b to the mobile terminal N7. Subsequently, the mobile terminal N4 restores the process result of the process 1b saved in the distributed shared memory areas Md of the mobile terminals N1 to N3, to the memory M of the mobile terminal N4, and waits for notification of the end of synchronizing stand-by for execution of the process 1b from the mobile terminal N1.

In this manner, the mobile terminal N4 saves the process result of the process 1b to the distributed shared memory areas Md during suspension of the process 1b of the group G1 and thereby, reserves a work area for the process 2b of the group G2. During the suspension of the process 1b, therefore, the mobile terminal N4 can execute the process 2b while protecting the result of the process 1b.

In this example, to execute the process 2b of the group G2, the mobile terminal N4 saves the process result of the process 1b to the distributed shared memory areas Md and reserves a work area. The mobile terminal N4, however, may save the process result of the process 1b to the distributed shared memory areas Md to reserve a work area in order to execute a process of a different group to which the mobile terminal N4 belongs other than the groups G1 and G2. The mobile terminal N4 may also save the process result of the process 1b to the distributed shared memory areas Md to reserve a work area in order to execute a new process having arisen in the mobile terminal N4.

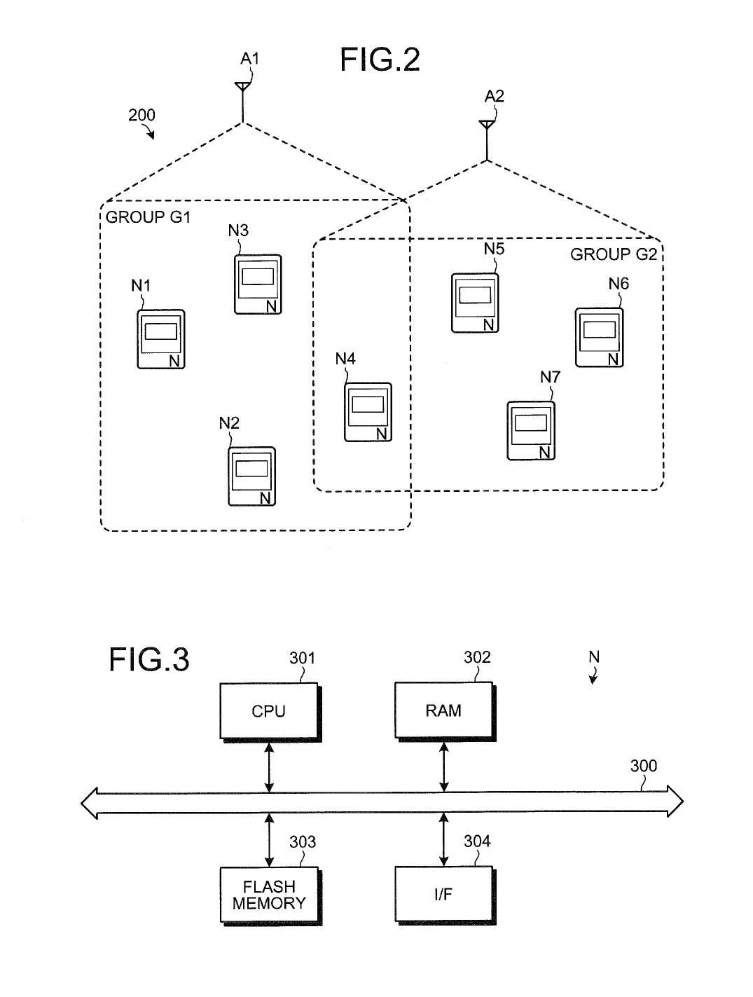

FIG. 2 is an explanatory diagram of an example of a network system according to the embodiment. In FIG. 2, a network system 200 includes multiple mobile terminals N (mobile terminals N1 to N7) and base stations A1 and A2. In the network system 200, the mobile terminals N are interconnected via the base stations A1 and A2.

Each mobile terminal N is a radio communication device that communicates with other terminals. The mobile terminals N include the mobile terminals N1 and N7 serving as master terminals that perform distributed processing. The mobile terminals N1 and N7 serving as the master terminals handle mobile terminals N connected to the base stations to which the mobile terminals N1 and N7 are connected, respectively, as slave terminals of groups that execute distributed processing.

For example, the mobile terminals N2 to N4 connected to the base station A1 to which the mobile terminal N1 serving as the master terminal is connected, serve as slave terminals of the group G1 that executes the distributed processing 1. The mobile terminals N4 to N6 connected to the base station A2 to which the mobile terminal N7 serving as the master terminal is connected, serve as slave terminals of the group G2 that executes the distributed processing 2.

Each of the mobile terminals N1 to N4 in the group G1 has the memory M. Each of the mobile terminals N1 to N3 in the group G1 has the distributed shared memory area Md in the memory M. The distributed shared memory area Md is an area accessible by each of the mobile terminals N1 to N4 in the group G1.

In this example, although the mobile terminal N4 does not have the distributed shared memory area Md in the memory M, configuration may be such that the mobile terminal N4 has the distributed shared memory area Md. The mobile terminals N1 to N3 have respective distributed shared memory areas Md in the respective memories M thereof. These distributed shared memory areas Md of the mobile terminals N1 to N3 may differ in size from each other.

In this example, although the network system 200 is built as the system that includes multiple mobile terminals N (mobile terminals N1 to N7) and the base stations A1 and A2, configuration may be such that the network system 200 is built as an ad hoc network that includes multiple mobile terminals N (mobile terminals N1 to N7) that are capable of ad hoc communication with the mobile terminal N serving as the master terminal and serve as a group that executes distributed processing.

The mobile terminals N capable of ad hoc communication are mobile terminals N within the communication range of the mobile terminal N1. In ad hoc communication, each mobile terminal N is equipped with a module for ad hoc communication and performs communication through the module.

The network system 200 may be built as a system that includes a personal computer (PC), a cellular phone, or a personal digital assistant (PDA), or may be built as a network including a base station and a gateway.

FIG. 3 is a block diagram of an example of a hardware configuration of the mobile terminal N according to the embodiment. In FIG. 3, the mobile terminal N includes a CPU 301, a random access memory (RAM) 302, a flash memory 303, and an interface (I/F) 304. The CPU 301 to the I/F 304 are interconnected to via a bus 300.

The CPU 301 supervises overall control of the mobile terminal N. The RAM 302 is used as a work area for the CPU 301. In the RAM 302, the distributed shared memory area Md is reserved. In other words, the RAM 302 is equivalent to the memory M. The flash memory 303 stores a program. The I/F 304 exchanges information with other terminals via the base stations A1 and A2.

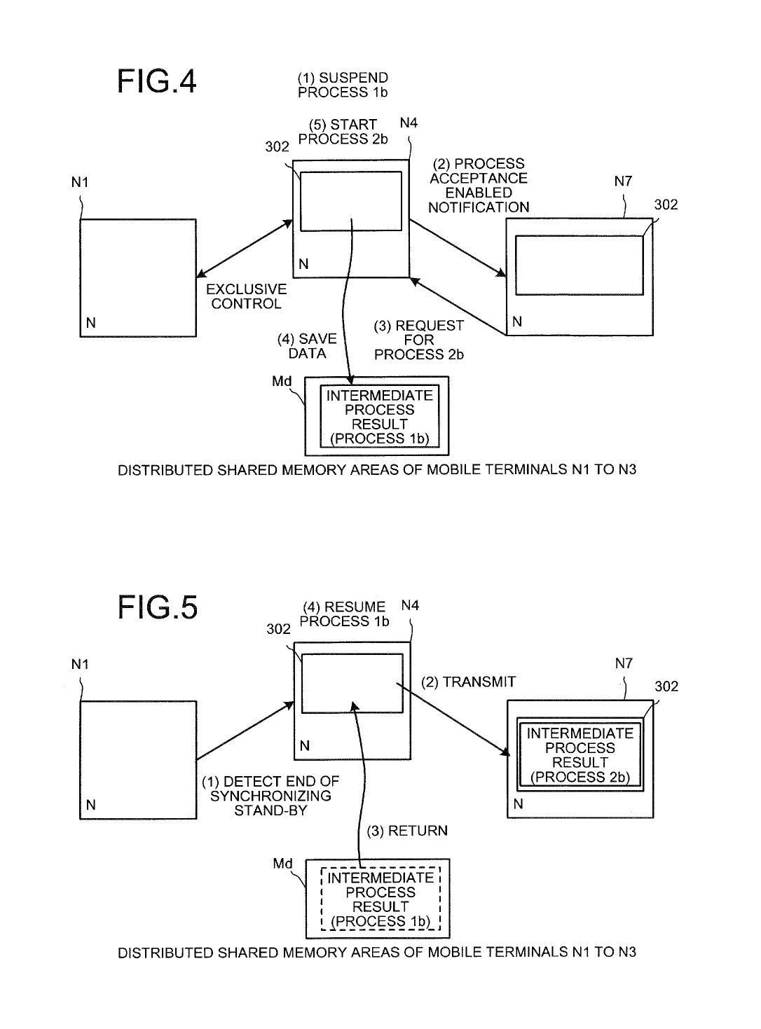

An example of use of the distributed shared memory area Md by the mobile terminal N will be described, referring to FIGS. 4 to 6. The description will be made using the mobile terminals N1, N4, and N7 of FIG. 2, which means that the mobile terminal N1 is the master terminal of the group G1 that executes the distributed processing 1 and that the mobile terminal N7 is the master terminal of the group G2 that executes the distributed processing 2. Hereinafter, for simplification, the base stations A1 and A2 through which mobile terminals N communicate with each other are not depicted.

The mobile terminal N4 is a slave terminal belonging to the group G1 and to the group G2, and executes distributed processing 1 and 2 based on process requests from the mobile terminals N1 and N7 serving as the master terminals. In the following description, the distributed shared memory areas Md of the mobile terminals N1 to N3 are described virtually as a single distributed shared memory area Md. Actually, however, portions of a process result are saved to the distributed shared memory areas Md of the mobile terminals N1 to N3, respectively. A specific example in which the mobile terminal 4 saves an intermediate process result to the distributed shared memory area Md will first be described, referring to FIG. 4.

FIG. 4 is an explanatory diagram of an example of saving of the intermediate process result of distributed processing by the mobile terminal. The mobile terminal N1 serving as the master terminal performs exclusive control/synchronization for the processes 1a and 1b of the distributed processing 1. This means that the mobile terminal N4 does not execute the process 1b during execution of the process 1a.

(1) First, the mobile terminal N4 detects the process 1b being queued, based on the processing status of the process 1a by the mobile terminal N1 serving as the master terminal of the group G1, and suspends the process 1b that is under execution. After suspending the process 1b, the mobile terminal N4 shifts to an idle state.

(2) The mobile terminal N4 then transmits notification that the CPU 301 has shifted to the idle state is able to accept a different process (hereinafter “process acceptance enabled notification”), to the mobile terminal N7 serving as the master terminal of the group G2.

(3) Receiving the process acceptance enabled notification from the mobile terminal N4, the mobile terminal N7 transmits to the mobile terminal N4, a request for the process 2b of the distributed processing 2.

(4) Receiving the request for the process 2b, the mobile terminal N4 saves the intermediate process result of the process 1b to the distributed shared memory area Md and thereby, reserves a work area for the requested process 2b. (5) The mobile terminal N4 then starts executing the requested process 2b.

Actually, the mobile terminal N4 saves portions of the intermediate process result of the process 1b in the respective distributed shared memory areas Md of the mobile terminals N1 to N3. For example, the mobile terminal N4 notifies the mobile terminal N1 serving as the master terminal, of a memory size needed for data saving (e.g., the data size of the intermediate process result of the process 1b). Receiving the notification of the memory size needed for data saving, the mobile terminal N1 serving as the master terminal notifies the mobile terminal N4 of a mobile terminal N serving as a data saving destination.

Because the speeds of communication between the mobile terminal N4 and the mobile terminals N1 to N3 differ from one another, the time required for saving/restoring of the intermediate process result of the process 1b varies according to the mobile terminals N selected as the data saving destination. For this reason, the mobile terminal N1 selects a mobile terminal N that is optimal as the data saving destination, based on position information of the mobile terminal N4 having the intermediate process result to be saved to the distributed shared memory area Md and on position information of the mobile terminals N1 to N3 in the group G1, and gives notification of the selected mobile terminal N.

The mobile terminal N1, for example, determines a mobile terminal N located close to the mobile terminal N4 to be a mobile terminal N that communicates at high speed with the mobile terminal N4, and adopts the mobile terminal N as the optimum mobile terminal N serving as the data saving destination. The mobile terminal N1, for example, may adopt a mobile terminal N having a large distributed shared memory area Md, as the optimum mobile terminal N serving as the data saving destination.

The mobile terminal N4 may transmit the intermediate process result to be saved to the mobile terminal N serving as the data saving destination and request the CPU 301 of the mobile terminal N to save the intermediate process result. When each mobile terminal N is configured to be capable of direct memory access control (DMAC), the mobile terminal N4 may write the intermediate process result directly to the RAM 302 without accessing the CPU 301 of the mobile terminal N serving as the data saving destination.

The mobile terminal N4 may have the distributed shared memory area Md itself. The mobile terminal N4, therefore, may save a portion of the intermediate process result to the distributed shared memory area Md thereof in addition to saving portions of the intermediate process result to the distributed shared memory areas Md of the mobile terminals N1 to N3.

In this manner, the mobile terminal N4 can save the intermediate process result of the process 1b to the distributed shared memory area Mb to protect the intermediate process result. The mobile terminal N4 uses the CPU 301 thereof in the idle state for execution of the process 2b that is different from the process 1b and thereby, improves the use efficiency of the CPU 301 of the mobile terminal N4. A specific example in which the mobile terminal N4 restores an intermediate process result saved in the distributed shared memory area Md to the work area of the mobile terminal N4 will be described, referring to FIG. 5.

FIG. 5 is an explanatory diagram of a specific example of the restoring of an intermediate process result saved in the distributed shared memory area to the work area of the mobile terminal by the mobile terminal. (1) When the mobile terminal N1 serving as the master terminal of the group G1 ends execution of the process 1a, the mobile terminal N4 detects the end of execution of the process 1a. (2) Having detected the end of exclusive control/synchronizing stand-by for the process 1b, the mobile terminal N4 transmits to the mobile terminal N7 serving as the master terminal of the group G2, the intermediate process result of the process 2b under execution.

(3) The mobile terminal N4 then restores the intermediate process result of the process 1b to a work area that is reserved by transmitting the intermediate process result of the process 2b to the mobile terminal N7. (4) The mobile terminal N4 resumes the process 1b based on the restored intermediate process result of the process 1b. The mobile terminal N4 restores the intermediate process result of the process 1b to the work area by making a request to the data saving destination mobile terminal N. The request is communicated from the mobile terminal N1 to the mobile terminal N4 as shown in FIG. 4, and is a request for transmission of the intermediate process result of the process 1b. The mobile terminal N4 may read the intermediate process result of the process 1b directly out of the RAM 302 of the data saving destination mobile terminal N.

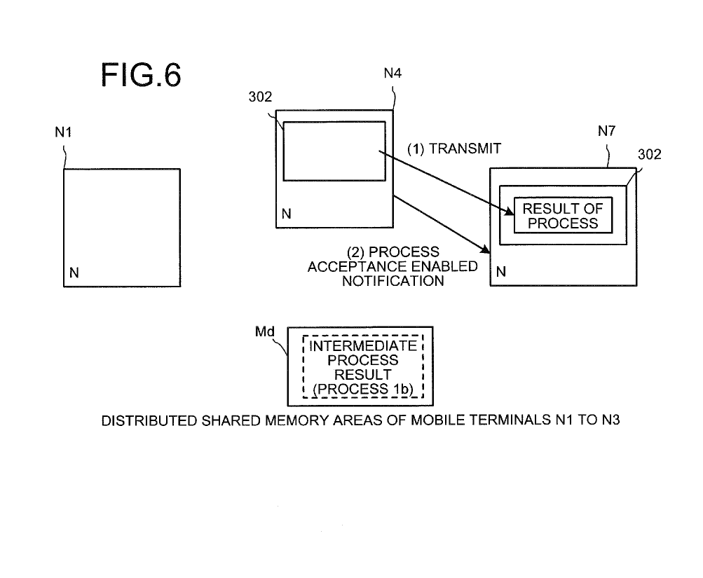

As a result, the mobile terminal N4 can resume the process 1b immediately upon receiving from the mobile terminal N1, a request to resume the process 1b. An example of a case of completing the process 2b of the group G2 will be described, referring to FIG. 6.

FIG. 6 is an explanatory diagram of an example of completing execution of a process of a different group by the mobile terminal. (1) When the mobile terminal N4 completes execution of the process 2b requested by the mobile terminal N7 serving as the master terminal of the group G2, the mobile terminal N4 transmits the process result of the process 2b to the mobile terminal N7.

(2) Because the CPU 301 of the mobile terminal N4 has shifted back to the idle state, the mobile terminal N4 transmits a process acceptance enabled notification to the mobile terminal N7 serving as the master terminal of the group G2, and waits for a process request. If the mobile terminal N4 receives from the mobile terminal N1 serving as the master terminal of the group G1 while waiting for a process request, a request to resume the process 1b, the mobile terminal N4 resumes the process 1b and transmits to the mobile terminal N7 serving as the master terminal of the group G2, notification of a cancellation of the process acceptance enabled notification.

When the CPU 301 shifts back to the idle state, the mobile terminal N4 may immediately restore the intermediate process result of the process 1b to the work area without waiting for a process request. The CPU 301 may wait for a request to resume the process 1b and resume the process 1b upon receiving the request.

In this manner, after ending execution of the process 2b, the mobile terminal N4 can execute a different process using the work area reserved by transmitting the process result of the process 2b to the mobile terminal N7.

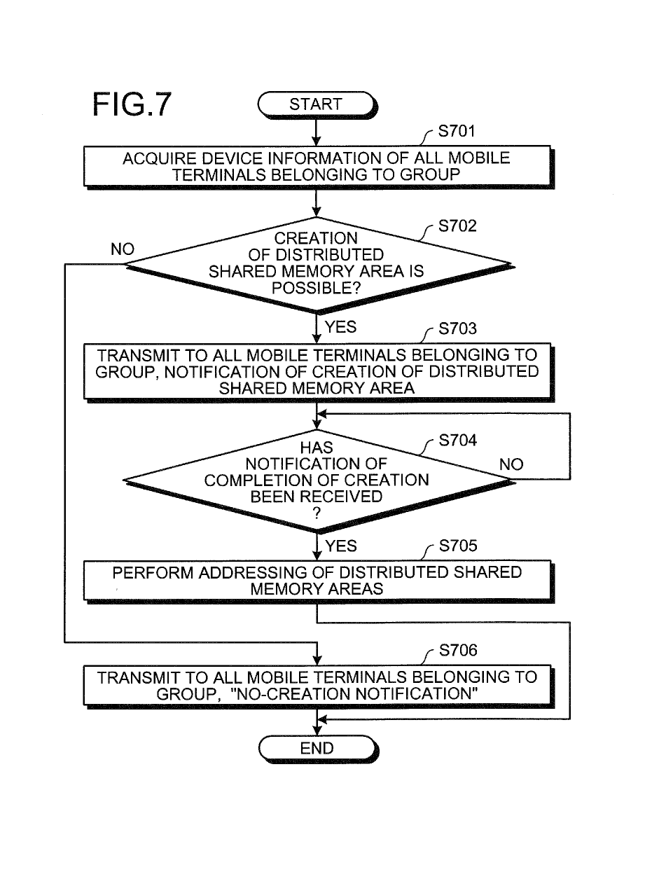

FIG. 7 is a flowchart of the details of a process of creating the distributed shared memory area by the master terminal. The CPU 301 first acquires device information of all mobile terminals N belonging to the group (step S701).

The CPU 301 then determines whether creating the distributed shared memory area is possible (step S702). For example, the CPU 301 determines that creating the distributed shared memory area is possible if the sum of memory sizes in the RAMS 302, provided by all the mobile terminals N belonging to the group (hereinafter “provided memory size”) is greater than or equal to the size of the minimum process result of any process of the distributed processing.

This means that when the provided memory size is not a size large enough to allow the intermediate process result of any process of the distributed processing to be saved therein, the CPU 301 concludes that creating the distributed shared memory area Md is unnecessary and thus, determines that creating the distributed shared memory area Md is not possible.

If creation of the distributed shared memory area Md is not possible (step S702: NO), the CPU 301 transmits to all the mobile terminals N belonging to the group, notification that creation of the distributed shared memory area Md is unnecessary (hereinafter “no-creation notification”) (step S706). The CPU 301 then ends the process of creating the distributed shared memory area Md.

If creation of the distributed shared memory area Md is possible (step S702: YES), the CPU 301 transmits to all the mobile terminals N belonging to the group, notification of the creation of the distributed shared memory area Md (step S703).

The CPU 301 then determines whether notification of the completion of the creation of the distributed shared memory area Md has been received from all mobile terminals N belonging to the group (step S704). If notification has not been received from all the mobile terminals N belonging to the group (step S704: NO), the CPU 301 returns to step S704 and waits for reception of the completion notification.

When having received from all mobile terminals N belonging to the group, notification of completion of the creation of the distributed shared memory area Md (step S704: YES), the CPU 301 performs addressing of the distributed shared memory areas Md (step S705). The CPU 301 then ends the process of creating the distributed shared memory area Md.

Addressing means assigning addresses to the memory to manage the memory. For example, a 32-bit value or 64-bit value is adopted as such an address.

In this manner, the mobile terminal N serving as the master terminal can cause a mobile terminal N serving as a slave terminal to create the distributed shared memory area Md. The mobile terminal N serving as the master terminal thus performs addressing of a memory area provided by a mobile terminal N belonging to the group and manages the distributed shared memory area Md.

When the sum of the provided memory sizes of all mobile terminals N belonging to the group is greater than or equal to the size of the minimum process result of the distributed processing, the mobile terminal N serving as the master terminal causes the mobile terminal N serving as the slave terminal to create the distributed shared memory area Md. In other words, the mobile terminal N serving as the master terminal causes the mobile terminal N serving as the slave terminal to create the distributed shared memory area Md if a distributed shared memory area Md can be created that has a size large enough to save the process result of the distributed processing. As a result, the slave terminal prevents use of the RAM 302 for distributed shared memory areas Md that need not be created.

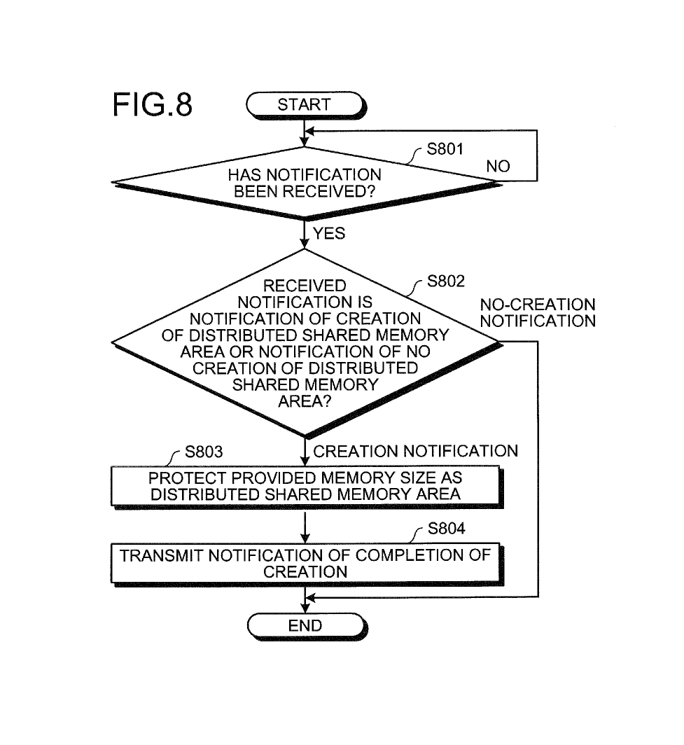

FIG. 8 is a flowchart of the details of the process of creating the distributed shared memory area by the mobile terminal.

The CPU 301 first determines whether notification from the mobile terminal N serving as the master terminal has been received (step S801). If notification has not been received (step S801: No), the CPU 301 returns to step S801 and waits for notification.

When notification has been received (step S801: YES), the CPU 301 determines whether the received notification is notification of creation of the distributed shared memory area Md or notification of no creation of the distributed shared memory area Md (step S802).

If the received notification is notification of no creation of the distributed shared memory area Md (step S802: no-creation notification), the CPU 301 ends the process of creating the distributed shared memory area Md without creating any distributed shared memory area Md. Configuration may be such that the mobile terminal N serving as the master terminal does not transmit notification of no creation of the distributed shared memory area Md. In such a case, the mobile terminals N determine whether creation of the distributed shared memory area Md is necessary based on the presence/absence of notification of creation of the distributed shared memory area Md.

If the received notification is notification of creation the distributed shared memory area Md (step S802: creation notification), the CPU 301 protects a provided memory size as the distributed shared memory area Md (step S803).

The CPU 301 then transmits to the mobile terminal N serving as the master terminal, notification of completion of the creation of the distributed shared memory area Md (step S804), and ends the process of creating the distributed shared memory area Md. In this manner, the mobile terminal N can create the distributed shared memory area Md.

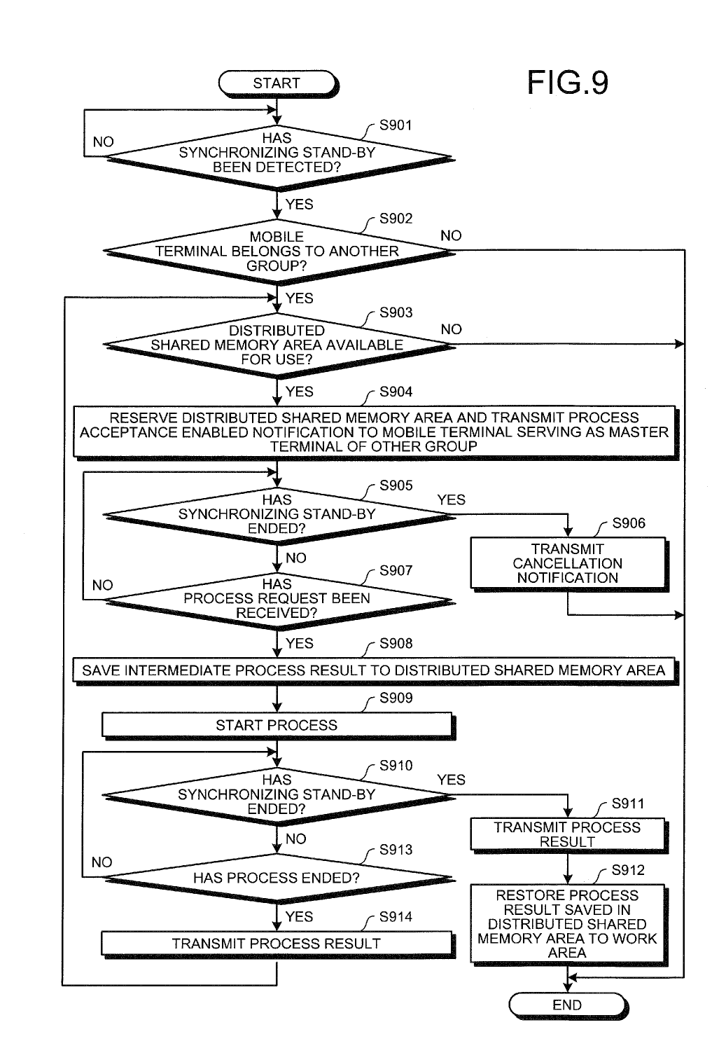

FIG. 9 is a flowchart of the details of a process of saving a process result to the distributed shared memory area by the mobile terminal N.

The CPU 301 first determines whether synchronizing stand-by for exclusive control by the mobile terminal N1 serving as the master terminal of a group involved in a process under execution has been detected (step S901). If not detected (step S901: NO), the CPU 301 returns to step S901 and waits for detection of synchronizing stand-by.

When having detected synchronizing stand-by (step S901: YES), the CPU 301 suspends the process under execution, for synchronizing stand-by. The CPU 301 then determines whether the mobile terminal N that includes the CPU 301 belongs to another group, in addition to the group involved in the process under execution (step S902).

If the mobile terminal N that includes the CPU 301 does not belong to another group (step S902: NO), the CPU 301 ends the process of saving a process result to the distributed shared memory area Md. If the mobile terminal N that includes the CPU 301 does not belong to another group, the CPU 301 will not receive a request to execute a process other than the suspended process and therefore, has no need of reserving a work area for another process. Thus, the CPU 301 concludes that there is no need of saving a process result from the RAM 302 to a distributed shared memory area Md, ending the process of saving a process result.

If the mobile terminal N that includes the CPU 301 belongs to another group (step S902: YES), the CPU 301 determines whether the distributed shared memory area Md is available for use (step S903). If the distributed shared memory area Md is not available for use (step S903: NO), the CPU 301 ends the process of saving a process result to the distributed shared memory area Md.

If the distributed shared memory area Md is available (step S903: YES), the CPU 301 reserves a distributed shared memory area Md for data saving and transmits a process acceptance enabled notification to the mobile terminal N2 serving as the master terminal of the other group to which the mobile terminal N that includes the CPU 301 belongs (step S904).

Because the distributed shared memory area Md is available for use, the CPU 301 determines that a work area for distributed processing by the other group to which the mobile terminal N that includes the CPU 301 belongs can be reserved, and therefore transmits the process acceptance enabled notification.

The CPU 301 then determines whether synchronizing stand-by has ended (step S905). Synchronizing stand-by is ended through reception of a synchronizing stand-by cancel notification from the mobile terminal N1 serving as the master terminal. When synchronizing stand-by has ended (step S905: YES), the CPU 301 transmits notification of cancellation of the process acceptance enabled notification to the mobile terminal N2 serving as the master terminal of the other group to which the mobile terminal N that includes the CPU 301 belongs (step S906), and ends the process of saving a process result to the distributed shared memory area Md.

Following the end of synchronizing stand-by, the CPU 301 resumes the suspended process and consequently, the CPU 301 cannot reserve a work area for distributed processing by the other group to which the mobile terminal N that includes the CPU 301 belongs. As a result, the CPU 301 transmits to the mobile terminal N2 serving as the master terminal of the other group to which the mobile terminal N that includes the CPU 301 belongs, notification of the cancellation of the process acceptance enabled notification.

If synchronizing stand-by has not ended (step S905: NO), the CPU 301 determines whether a process request has been received from the mobile terminal N2 serving as the master terminal of the other group to which the mobile terminal N that includes the CPU 301 belongs (step S907). If no process request has been received (step S907: NO), the CPU 301 returns to step S905.

If a process request has been received (step S907: YES), the CPU 301 saves an intermediate process result to the distributed shared memory area Md (step S908) and thereby, reserves a work area for the process to be executed according to the process request. Based on the process request, the CPU 301 then starts the process (step S909).

The CPU 301 determines whether synchronizing stand-by has ended (step S910). Synchronizing stand-by is ended, for example, through reception of a synchronizing stand-by cancellation notification from the mobile terminal N1 serving as the master terminal.

When synchronizing stand-by has ended (step S910: YES), the CPU 301 transmits the process result of the process started at step S909, to the mobile terminal N2 serving as the master terminal of the other group to which the mobile terminal N that includes the CPU 301 belongs (step S911).

The CPU 301 then restores the process result saved in the distributed shared memory area Md to the work area (step S912), and ends the process of saving a process result to the distributed shared memory area Md. In this manner, the CPU 301 transmits the process result of the process started at step S909 and thereby, reserves a work area for the process kept suspended because of synchronizing stand-by. The CPU 301 then restores the process result saved in the distributed shared memory area Md to the work area and resumes the suspended process.

If synchronizing stand-by has not ended (step S910: NO), the CPU 301 determines whether the process started at step S909 has ended (step S913). If the process has not ended (step S913: NO), the CPU 301 returns to step S910.

If the process has ended (step S913: YES), the CPU 301 transmits the process result of the process started at step S909, to the mobile terminal N2 serving as the master terminal of the other group to which the mobile terminal N that includes the CPU 301 belongs (step S914), and returns to step S903. Because transmission of the process result puts the work area in an available state, the CPU 301 returns to step S903 to wait for another process request.

Following the end of the process started at step S909, the CPU 301 may restore the process result saved in the distributed shared memory area Md to the work area. The CPU 301 then may resume the suspended process when synchronizing stand-by is ended.

In this manner, the mobile terminal saves the process result to the distributed shared memory area Md and thereby, reserves a work area of the RAM 302 for a different process. The mobile terminal restores the process result saved in the distributed shared memory area Md to the work area of the RAM 302, thereby resumes the process.

As described above, according to the data processing method and the mobile terminal N, when the process 1b of the group G1 is suspended to put the CPU 301 in an idle state, the process result of the process 1b in the RAM 302 is saved to the distributed shared memory area Md. This allows the CPU 301 to receive a request for the process 2b of the group G2.

By using the CPU 301 in the idle state for a different process, the utilization efficiency of the CPU of the mobile terminal N can be improved and the overall processing speed of the groups G1 and G2 can also be improved. By restoring the process result of the process 1b saved in the distributed shared memory area Md to the work area, the suspended process 1b can be resumed.

The data processing method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to one aspect of the embodiment, an effect is achieved such that a process result saved in a memory is protected.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing method executed by a first device, the data processing method comprising:
suspending execution of a first process by the first device that belongs to a first device group that includes a plurality of devices;
saving based on a request for execution of a second process from a second device that belongs to a second device group that includes a plurality of devices, process information of the first process to shared memory that is set in each of the devices of the first device group and shared by the devices of the first device group; and
releasing the saving of the process information of the first process consequent to completion of the execution of the second process.

2. The data processing method according to claim 1, wherein
the first device further belongs to the second device group.

3. The data processing method according to claim 1, wherein
the first device includes a first memory area used for executing any one among the first process and the second process, and transfers the process information of the first process to the first memory area consequent to completion of the execution of the second process.

4. The data processing method according to claim 1, wherein
the first device group communicates with a first base station and the second device group communicates with a second base station.

5. The data processing method according to claim 1, wherein
the first device group is included in a first ad hoc communication network and the second device group is included in a second ad hoc communication network.

6. The data processing method according to claim 1, wherein
the first device suspends execution of the first process, based on a synchronization request from a third device of the first device group.

7. The data processing method according to claim 6, wherein
the first device starts execution of the suspended first process, based on cancellation notification from the third device.

8. The data processing method according to claim 1, wherein
a third device belonging to the first device group sets the shared memory based on a comparison process result, when a sum of provided memory sizes of all the devices belonging to the first device group is at least a minimum size of distributed processing.

9. A mobile terminal comprising:
a processor configured to:
suspend execution of a first process by the mobile terminal that belongs to a first device group that includes a plurality of devices;
save based on a request for execution of a second process from a second device that belongs to a second device group that includes a plurality of devices, process information of the first process to shared memory that is set in each of the devices of the first device group and shared by the devices of the first device group; and
release the saved process information of the first process consequent to completion of the execution of the second process.
